(19) United States
(12) Patent Application Publication
(10) Pub. No.: US 2015/0286493 A1
(43) Pub. Date: Oct. 8, 2015

(54) VIRTUAL-MACHINE PLACEMENT BASED ON INFORMATION FROM MULTIPLE DATA CENTERS

(71) Applicant: Strato Scale Ltd., Herzlia (IL)

(72) Inventors: Rotem Dafni, Tel Aviv (IL); Mille Gandelsman, Haifa (IL)

(21) Appl. No.: 14/675,844

(22) Filed: Apr. 1, 2015

Related U.S. Application Data
(60) Provisional application No. 61/974,479, filed on Apr. 3, 2014.

(51) Int. Cl. G06F 9/455; H04L 12/911; G06F 9/50

(52) U.S. Cl. CPC G06F 9/45558; G06F 9/505; H04L 47/829; G06F 2009/4557

(57) ABSTRACT

A method includes collecting performance characteristics of first workloads that run on first hosts in a first computer network. One or more placement directives, for assigning workloads to hosts, are derived from the performance characteristics of the first workloads. Second workloads are assigned to second hosts in a second computing system that is separate from the first computing system, in accordance with the placement directives.

### CROSS-REFERENCE TO RELATED APPLICATIONS

This application claims the benefit of U.S. Provisional Patent Application 61/974,479, filed Apr. 3, 2014, whose disclosure is incorporated herein by reference.

### FIELD OF THE INVENTION

The present invention relates generally to virtualized computing, and particularly to methods and systems for Virtual-Machine (VM) placement.

### BACKGROUND OF THE INVENTION

Machine virtualization is commonly used in various computing environments, such as in data centers and cloud computing. Various virtualization solutions are known in the art. For example, VMware, Inc. (Palo Alto, Calif.), offers virtualization software for environments such as data centers and cloud computing. Virtualized computing systems often run VM placement processes for selecting which physical host is to run a given VM.

### SUMMARY OF THE INVENTION

An embodiment of the present invention that is described herein provides a method including collecting performance characteristics of first workloads that run on first hosts in a first computer network. One or more placement directives, for assigning workloads to hosts, are derived from the performance characteristics of the first workloads. Second workloads are assigned to second hosts in a second computing system that is separate from the first computing system, in accordance with the placement directives.

In some embodiments, the first and second computer networks include virtualized data centers, and the first and second workloads include Virtual Machines (VMs). In an embodiment, deriving the placement directives includes classifying the first workloads into classes depending on the performance characteristics, and specifying the placement directives in terms of the classes. In another embodiment, assigning the second workloads to the second hosts includes predicting a resource usage pattern of a second workload based on a placement directive derived from the first workloads, and assigning the second workload to a second host based on the predicted resource usage pattern.

In a disclosed embodiment, collection of the performance characteristics and application of the placement directives are performed by local placement units in the first and second computer systems, and derivation of the placement directives is performed by a global placement unit external to the first and second computer networks. In another embodiment, collecting the performance characteristics includes collecting temporal resource usage patterns of the first workloads.

In yet another embodiment, collecting the performance characteristics includes collecting communication interaction between two or more of the first workloads. In still another embodiment, the method includes estimating available resources of the first hosts, and deriving the placement directives includes specifying the placement directives based on the estimated available resources.

In an embodiment, collecting the performance characteristics includes gathering the performance characteristics over the first and second workloads in both the first computer network and the second computer network, and deriving the placement directives includes specifying the placement directives based on the performance characteristics gathered over the first and second computer networks. In some embodiments, the method may include assigning one or more physical resources of one or more of the second hosts in the second computing system to one or more of the second workloads, based on the collected performance characteristics.

There is additionally provided, in accordance with an embodiment of the present invention, a system including first and second local placement units, and a global placement unit. The first local placement unit is configured to collect performance characteristics of first workloads that run on first hosts in a first computer network. The global placement unit is configured to derive from the performance characteristics of the first workloads one or more placement directives for assigning workloads to hosts. The second local placement unit is configured to assign second workloads to second hosts in a second computing system that is separate from the first computing system, in accordance with the placement directives.

There is further provided, in accordance with an embodiment of the present invention, an apparatus including an interface and a processor. The interface is configured to communicate with first and second separate computer networks. The processor is configured to receive via the interface performance characteristics of first workloads that run on first hosts in the first computer network, to derive from the performance characteristics of the first workloads one or more placement directives for assigning workloads to hosts, and to send the directives via the interface to the second computing system, for use in assigning second workloads to second hosts in the second computing system.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a VM placement system, in accordance with an embodiment of the present invention; and

FIG. 2 is a flow chart that schematically illustrates a method for VM placement, in accordance with an embodiment of the present invention.

### DETAILED DESCRIPTION OF EMBODIMENTS

### Overview

Embodiments of the present invention that are described herein provide improved methods and systems for placement of workloads in computer networks. In the present context, the term “placement” means the assignment of workloads to physical hosts, including the decision of which workload is to run on which host. Placement of a given workload may be performed before or after the workload is provisioned and running. The latter process is often referred to as migration.

The embodiments described herein refer mainly to placement of Virtual Machines (VMs) in virtualized data centers. The disclosed techniques, however, can be used with various other types of workloads and in various other types of computer networks.

In the disclosed embodiments, multiple separate data centers are provisioned with respective software components referred to as local placement units. In addition, a global placement unit communicates with the various local placement units, e.g., as a cloud service. Each local placement unit collects performance characteristics of VMs running in its respective data center. The global placement unit accumulates the performance characteristics collected across the multiple data centers, and derives VM placement directives from the accumulated performance characteristics. The placement directives are sent back to the local placement units, which in turn apply them in their respective data centers.

For example, several classes of VMs may be defined, e.g., short-lived VMs, bursty VMs, or pairs of VMs that tend to communicate extensively with one another. The placement directives may specify how to classify a VM into one of the classes, and how to place VMs of that class. In this manner, the local placement units are able to predict the resource usage patterns of VMs, and to assign them to host accordingly.

When using the disclosed techniques, VM placement in one data center can be optimized using information collected in another data center. Such a technique is advantageous, for example, in small or new data centers that can benefit from information collected in larger or more mature data centers. Moreover, the disclosed techniques enable the global placement unit to specify, test and refine placement directives over a large number of VMs and hosts, beyond the scale of any individual data center. As such, the placement directives are typically more accurate and enable each individual data center to better utilize its available resources.

Moreover, when using the disclosed techniques, a local placement unit in a given data center may use the workload performance characteristics collected in another data center for assigning physical host resources (e.g., CPU, memory or network resources) to VMs in the local data center.

### System Description

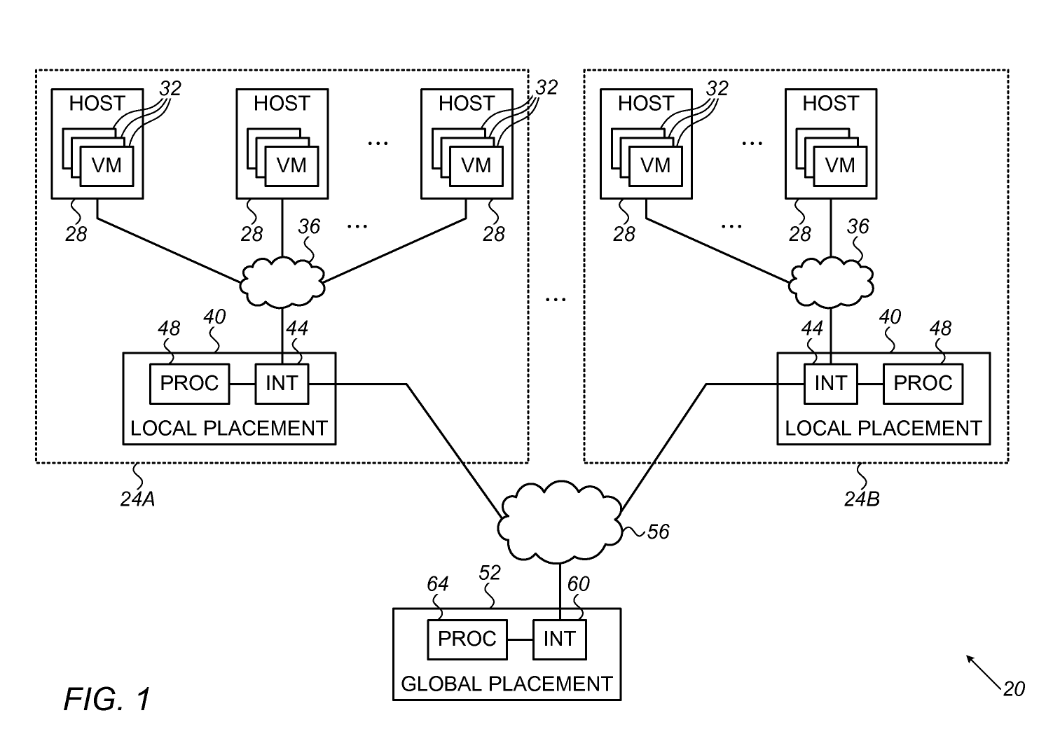

FIG. 1 is a block diagram that schematically illustrates a VM placement system 20, in accordance with an embodiment of the present invention. System 20 operates across multiple data centers. The example of FIG. 1 shows only two data centers 24A and 24B, for the sake of clarity. Alternatively, however, system 20 may operate over any desired number of data centers. Data centers 24 are typically separate from one another, and may be operated by different parties.

Each data center comprises physical hosts 28 that are connected by a communication network 36. Each host runs one or more Virtual Machines (VMs) 32. The VMs consume physical resources of the hosts, e.g., memory, CPU and networking resources. Hosts 28 may comprise, for example, servers, workstations or any other suitable computing platforms. Network 36 may comprise, for example, an Ethernet or Infiniband Local-Area Network (LAN).

In some embodiments, each data center 24 comprises a respective local placement unit 40, which carries out the various tasks relating to placement of VMs in that data center. In addition, system 20 comprises a global placement unit 52, which specifies VM placement directives based on information collected across the multiple data centers. The functions of local placement units 40 and global placement unit 52 are described in detail below.

Local placement units 40 communicate with global placement unit 52 over a Wide-Area Network 56, such as the Internet. Each local placement unit 40 comprises a network interface 44 for communicating with hosts 28 of its respective data center over network 36, and for communicating with global placement unit 52 over network 56. Each local placement unit further comprises a processor 48 that carries out the various processing tasks of the local placement unit. Global placement unit 52 comprises a network interface 60 for communicating with local placement units 40 over network 56, and a processor 64 that carries out the various processing tasks of the global placement unit.

The system configuration shown in FIG. 1 is an example configuration that is chosen purely for the sake of conceptual clarity. In alternative embodiments, any other suitable system configuration can be used. For example, although the embodiments described herein refer mainly to placement of VMs, the disclosed techniques can be used for placement of any other suitable type of workload, such as applications and/or operating-system processes or containers. Although the embodiments described herein refer mainly to virtualized data centers, the disclosed techniques can be used for placement of workloads in any other suitable type of computer systems.

The various elements of system 20, and in particular the elements of placement units 40 and/or 52, may be implemented using hardware/firmware, such as in one or more Application-Specific Integrated Circuit (ASICs) or Field-Programmable Gate Array (FPGAs). Alternatively, some system elements, e.g., processors 48 and/or 64, may be implemented in software or using a combination of hardware/firmware and software elements. In some embodiments, processors 48 and/or 64 comprise general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Placement Directives Based on Performance Characteristics Collected Over Multiple Data Centers

As part of the on-going operation of each data center 24, each local placement unit 40 makes placement decisions and assigns VMs 32 to hosts 28 accordingly. Placement decisions are based, for example, on the performance characteristics of the VMs and on the available physical resources (e.g., CPU, memory and networking resources) of the hosts. Placement decisions typically aim to predict the future resource consumption of VMs, and to assign VMs to hosts so as to best provide the required resources.

Each local placement unit 40 typically assigns VMs 32 to hosts 28 by applying a set of placement directives. In some embodiments, the placement directives are specified by global placement unit 52, based on information collected across the multiple data centers 24.

Local placement units 40 typically collect various performance characteristics of VMs 32. Performance characteristics of a given VM may comprise, for example, the size of the image from which the VM was created, the profile of memory, CPU and networking resource usage over time, the VM temporal usage pattern (e.g., start times, stop times, usage durations). Local placement units 40 report these performance characteristics to global placement unit 52, which uses them to specify placement directives.

In some embodiments, local placement units 40 classify VMs 32 into several classes, and the placement directives are also defined in terms of the classes. By classifying a given VM, local placement unit 40 is able to predict the expected resource usage pattern of the VM, and assign it to a host that will be able to provide the expected resources.

For example, the placement directives may specify how to identify and place a short-lived VM, e.g., a VM that starts, performs a number of computations in a short time duration, saves the results and stops. Assume, for example, that most short-lived VMs are created from an image of a certain size. A placement directive may thus specify that a VM having such an image size should be placed on a host that will be able to provide certain specified memory/CPU/networking resources in the next specified time duration.

In practice, the behavior of short-lived VMs may be well defined and classified in one data center, e.g., because it is a large data center or because it has been in operation for a long time. Another data center, which may be new or small, may benefit from the placement directives derived from the VMs of the former data center.

As another example, some VMs may be classified as “bursty” VMs, i.e., VMs that consume little or no resources during most of the time, except for a short time period in which the resource consumption spikes to a large value. If bursty VMs are common in one data center but rare in another data center, it is possible to use the information from the first data center in order to specify how to identify and place a bursty VM. This placement directive can then be applied effectively in the second data center.

As yet another example, based on analysis in a first data center, a pair of VMs having certain performance characteristics may be known to communicate extensively with one another. Using this information, global placement unit 52 may define a directive for placing such VMs on the same host. This directive may be applied by the local placement unit of a second data center, even though the second data center does not have sufficient statistics for deriving such a directive.

The placement directives described above are depicted purely by way of example. In alternative embodiments, system 20 may define and apply any other suitable placement directives based on any other suitable VM performance characteristics. In some embodiments, local placement units 40 also report the available resources of the various hosts to global placement unit 52. The global placement unit may consider the reported resources in deriving the placement directives.

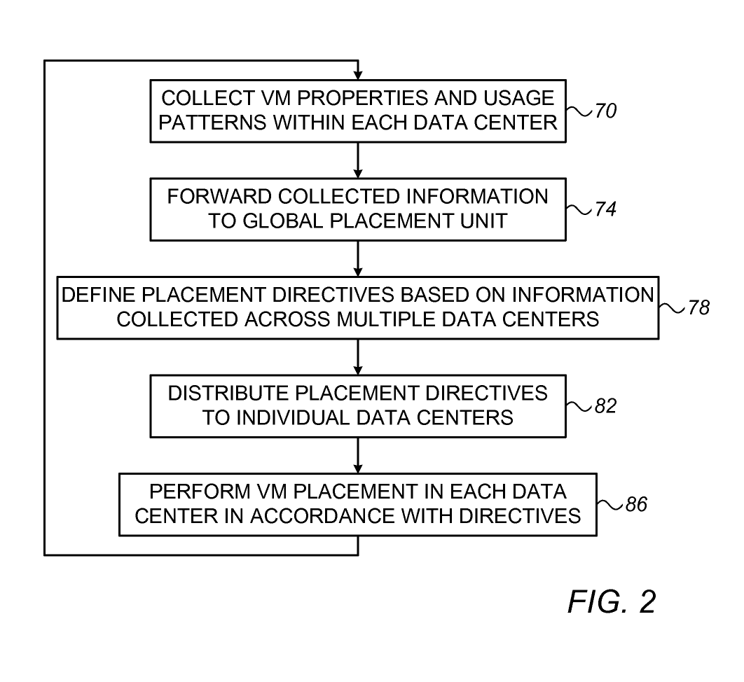

FIG. 2 is a flow chart that schematically illustrates a method for VM placement, in accordance with an embodiment of the present invention. The method begins with local placement units 40 collecting VM performance characteristics, e.g., usage patterns, at a collection step 70. Each local placement unit collects the information over the VMs in its respective data center. Local placement units 40 forward the collected information to global placement unit 52, at a forwarding step 74.

Global placement unit 52 derives one or more VM placement directives from the information collected across the multiple data centers, at a directive derivation step 78. For example, as explained above, the directives may specify how to identify that a VM belongs to a given class, and how to place VMs of that class.

Global placement unit 52 distributes the placement directives to local placement units 40 in the various data centers, at a directive distribution step 82. In each data center, local placement unit 40 assigns VMs to hosts based on the directives, at a placement step 86. The process of FIG. 2 is typically on-going, i.e., repeated and updated over time.

Although the embodiments described herein mainly address placement of VMs or other workloads, the methods and systems described herein can also be used in other applications. For example, a local placement unit 40 in a given data center may use the workload performance characteristics collected in another data center for assigning physical host resources (e.g., CPU, memory or network resources) to workloads.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
collecting performance characteristics of first workloads that run on first hosts in a first computer network;
deriving from the performance characteristics of the first workloads one or more placement directives for assigning workloads to hosts; and
assigning second workloads to second hosts in a second computing system that is separate from the first computing system, in accordance with the placement directives.

2. The method according to claim 1, wherein the first and second computer networks comprise virtualized data centers, and wherein the first and second workloads comprise Virtual Machines (VMs).

3. The method according to claim 1, wherein deriving the placement directives comprises classifying the first workloads into classes depending on the performance characteristics, and specifying the placement directives in terms of the classes.

4. The method according to claim 1, wherein assigning the second workloads to the second hosts comprises predicting a resource usage pattern of a second workload based on a placement directive derived from the first workloads, and assigning the second workload to a second host based on the predicted resource usage pattern.

5. The method according to claim 1, wherein collection of the performance characteristics and application of the placement directives are performed by local placement units in the first and second computer systems, and wherein derivation of the placement directives is performed by a global placement unit external to the first and second computer networks.

6. The method according to claim 1, wherein collecting the performance characteristics comprises collecting temporal resource usage patterns of the first workloads.

7. The method according to claim 1, wherein collecting the performance characteristics comprises collecting communication interaction between two or more of the first workloads.

8. The method according to claim 1, and comprising estimating available resources of the first hosts, wherein deriving the placement directives comprises specifying the placement directives based on the estimated available resources.

9. The method according to claim 1, wherein collecting the performance characteristics comprises gathering the performance characteristics over the first and second workloads in both the first computer network and the second computer network, and wherein deriving the placement directives comprises specifying the placement directives based on the performance characteristics gathered over the first and second computer networks.

10. The method according to claim 1, further comprising assigning one or more physical resources of one or more of the second hosts in the second computing system to one or more of the second workloads, based on the collected performance characteristics.

11. A system, comprising:
a first local placement unit, which is configured to collect performance characteristics of first workloads that run on first hosts in a first computer network;
a global placement unit, which is configured to derive from the performance characteristics of the first workloads one or more placement directives for assigning workloads to hosts; and
a second local placement unit, which is configured to assign second workloads to second hosts in a second computing system that is separate from the first computing system, in accordance with the placement directives.

12. The system according to claim 11, wherein the first and second computer networks comprise virtualized data centers, and wherein the first and second workloads comprise Virtual Machines (VMs).

13. The system according to claim 11, wherein the global placement unit is configured to classify the first workloads into classes depending on the performance characteristics, and to derive the placement directives in terms of the classes.

14. The system according to claim 11, wherein the second local placement unit is configured to predict a resource usage pattern of a second workload based on a placement directive derived from the first workloads, and to assign the second workload to a second host based on the predicted resource usage pattern.

15. The system according to claim 11, wherein the first local placement unit is configured to collect temporal resource usage patterns of the first workloads.

16. The system according to claim 11, wherein the first local placement unit is configured to collect communication interaction between two or more of the first workloads.

17. The system according to claim 11, wherein the first local placement unit is configured to estimate available resources of the first hosts, and wherein the global placement unit is configured to specify the placement directives based on the estimated available resources.

18. The system according to claim 11, wherein the first and second local placement units are configured to gather the performance characteristics over the first and second workloads in both the first computer network and the second computer network, and wherein the global placement unit is configured to derive the placement directives based on the performance characteristics gathered over the first and second computer networks.

19. The system according to claim 11, wherein the second local placement unit is configured to assign one or more physical resources of one or more of the second hosts in the second computing system to one or more of the second workloads, based on the collected performance characteristics.

20. Apparatus, comprising:
an interface, which is configured to communicate with first and second separate computer networks; and
a processor, which is configured to receive via the interface performance characteristics of first workloads that run on first hosts in the first computer network, to derive from the performance characteristics of the first workloads one or more placement directives for assigning workloads to hosts, and to send the directives via the interface to the second computing system, for use in assigning second workloads to second hosts in the second computing system.

21. The apparatus according to claim 20, wherein the first and second computer networks comprise virtualized data centers, and wherein the first and second workloads comprise Virtual Machines (VMs).

22. The apparatus according to claim 20, wherein the processor is configured to classify the first workloads into classes depending on the performance characteristics, and to derive the placement directives in terms of the classes.
